(19) United States
(12) Patent Application Publication
(10) Pub. No.: US 2018/0128177 A1
(43) Pub. Date: May 10, 2018

(54) METHOD FOR FORMING A HOLE IN AN ENGINE COMPONENT

(71) Applicant: General Electric Company, Schenectady, NY (US)

(72) Inventors: Thomas George Holland, Cincinnati, OH (US); Mehmet Muhittin Dede, Liberty Township, OH (US); Ryan Nicholas Porter, Jamestown, OH (US); Byron Andrew Pritchard, Jr., Loveland, OH (US); Jason Randolph Allen, Loveland, OH (US)

(21) Appl. No.: 15/344,841

(22) Filed: Nov. 7, 2016

(51) Int. Cl. F02C 7/18; F23R 3/00; B24C 1/08

(52) U.S. Cl. CPC F02C 7/18; F05D 2230/13; B24C 1/083; F23R 3/002

(57) ABSTRACT

A method of forming a hole in an engine component. The hole is formed through a wall defining first and second opposing surfaces. An inlet is located on the first surface and an outlet on the second surface where a passage connects the inlet and the outlet. Fluid is passed through the passage, emitted from the passage, and redirected upon existing the outlet.

### BACKGROUND OF THE INVENTION

Turbine engines, and particularly gas or combustion turbine engines, are rotary engines that extract energy from a flow of combusted gases passing through the engine onto a multitude of rotating turbine blades. The combusted gases cause extremely hot operating conditions for engine components. Cooling the engine components is necessary to lengthen the life of the engine and improve efficiency of the engine.

Engine components such as combustor liners and blades need cooling for durability. Multiple cooling holes are the main method of providing cooling. These holes are rapidly drilled by laser machines. Due to high laser energy the inlets and outlets of these holes have sharp jagged edges and the outlet shape can be very rough. These holes are usually fed by a cross flow resulting in a sharp turn for the cooling air. This generates many small recirculation zones causing excess amount of dust buildup which eventually causes major reduction of cooling flow or blockage.

### BRIEF DESCRIPTION OF THE INVENTION

In one aspect, a method of forming a hole in a wall of an engine component for a turbine engine, with the wall defining first and second surfaces separating a hot flow from a cooling flow, the method comprising forming the hole in the wall such that the hole has an inlet on the first surface, an outlet on the second surface, a passage connecting the inlet and the outlet, smoothing an interior of the passage by passing an abrading fluid through the passage and elongating the outlet by redirecting the abrading fluid as it exits the outlet over an edge defining the outlet to abrade the edge.

In another aspect, a method of forming a cooling hole in an engine component having a first surface with an inlet and a second surface with an outlet comprising using a laser to form the cooling hole with a roughened interior passage connecting the inlet to the outlet, passing an abrading fluid from the inlet to the outlet through the cooling hole to smooth the roughened interior passage of the cooling hole, and redirecting the abrading fluid at the outlet to elongate the outlet.

### BRIEF DESCRIPTION OF THE DRAWINGS

In the drawings:

FIG. 1 is a schematic cross-sectional diagram of a gas turbine engine for an aircraft.

FIG. 2 is perspective view of a combustor for the gas turbine engine of FIG. 1.

FIG. 3 is cross-sectional view of a cooling hole for a combustor liner of the combustor of FIG. 2.

FIG. 4 is cross-sectional view of the cooling hole of FIG. 3 with accumulated dust.

FIG. 5 is a schematic drawing illustrating cleaning and shaping of the cooling hole of FIG. 2.

FIG. 6 is a schematic drawing illustrating another form of cleaning and shaping the cooling hole of FIG. 2.

FIG. 7 is a cross-sectional view of the cooling hole of FIG. 2 after it has been cleaned and shaped.

### DESCRIPTION OF EMBODIMENTS OF THE INVENTION

The described embodiments of the present invention are directed to cleaning and shaping a cooling hole for an engine component. While illustrated as a cooling hole for a combustor liner, it is understood that cooling holes are used in many engine components, by way of non-limiting example blades, vanes, domes, shrouds, and that the methods described herein can be implemented for other such cooling holes. For purposes of illustration, the present invention will be described with respect to the turbine for an aircraft gas turbine engine. It will be understood, however, that the invention is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

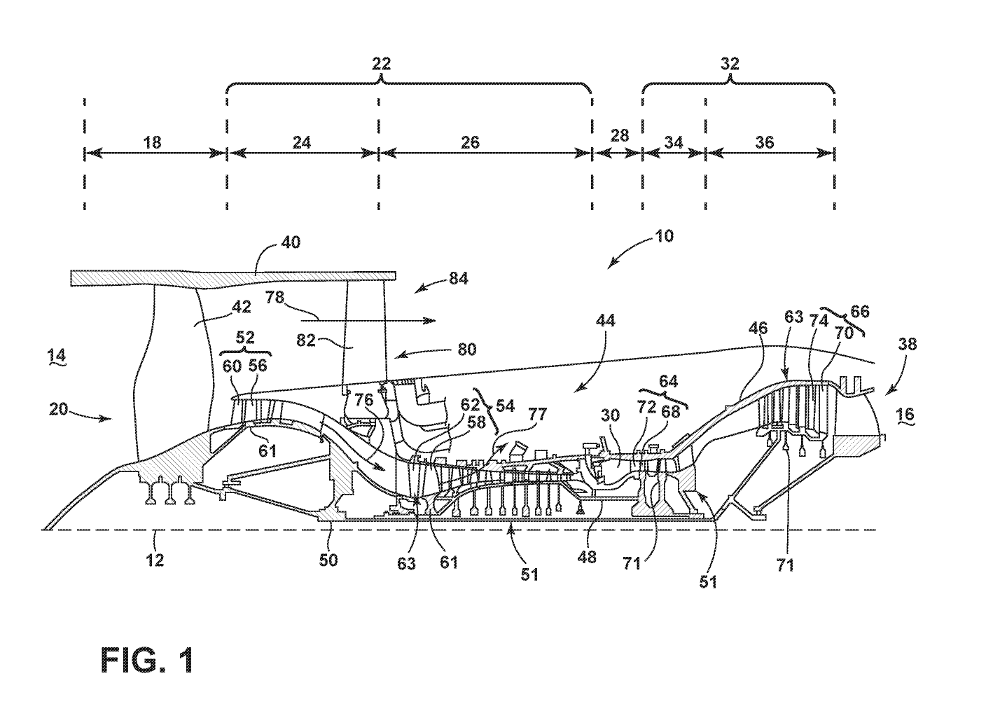

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, collectively defining rotors 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are the combustor 30 and downstream of the combustor especially the turbine section 32. Other sources of cooling fluid can be, but are not limited to, fluid discharged from the LP compressor 24 or the HP compressor 26.

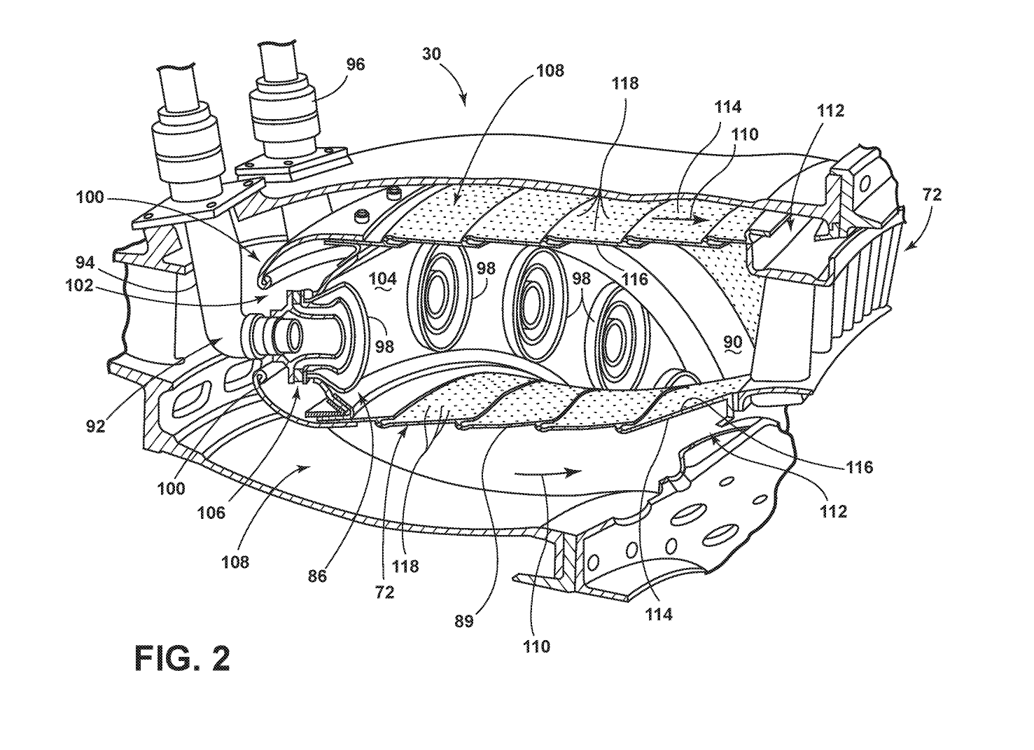

FIG. 2 is a perspective view of the combustor 30 of the engine 10 of FIG. 1 with a portion cut away. The combustor 30 includes a deflector assembly 86 and an engine component in the form of a combustion liners 88 to define a combustion chamber 90.

The combustor 30 further comprises a fuel nozzle 92 for emitting and igniting a fuel/air mixture into the combustion chamber 90. The fuel nozzle 92 includes a fuel line 94 mounted to the combustor 30 at a mount 96. A fuel/air mixture is emitted into the combustion chamber 90 from a swirler 98, which swirls the fuel/air mixture as it enters the combustion chamber 90. The deflector assembly 86 comprises a deflector 100 disposed forward of the swirler 98.

A gap 102 is defined between the deflector 100 and the fuel line 94, providing fluid communication between the compressor section 26 and the combustor 30. A circular rear wall 104 separates the combustion chamber 90 from the gap 102. The rear wall 104 is disposed radially with respect to the engine centerline 12, separating and supporting fuel nozzles 92.

Air is provided to the fuel nozzle 92 from the gap 102 and through a plurality of inlets 106 disposed in the swirler 98, such that the air mixes with fuel injected from the fuel line 94 to create the fuel/air mixture.

A set of bypass channels 108, one disposed radially inside the combustor 30 and one disposed radially outside of the combustor 30, relative to the engine centerline 12 provide a flow of fluid 110 from the compressor section 26 to the turbine section 34 bypassing the combustor 30 through a set of openings 112.

The combustion liner 88 comprises a wall 89 having an outer periphery or first surface 114 adjacent to the bypass channel 108 and an inner periphery or second surface 116 adjacent to the combustion chamber 90. The surfaces 114, 116 include a plurality of holes 118, for example cooling holes, providing fluid communication between the set of bypass channels 108 and the combustion chamber 90 providing a layer of cooling film along the inner surface of the combustion liner 88.

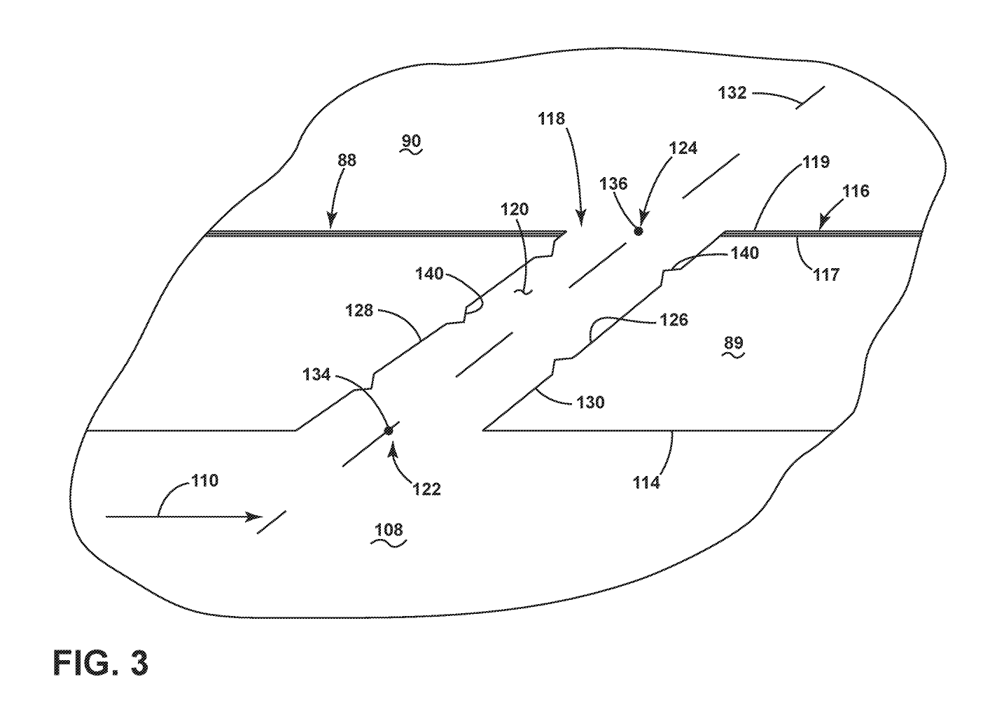

FIG. 3 is an enlarged partial cross-sectional view of a portion of the combustion liner 88 to illustrate the relationship between the cooling hole 118 and the first and second surfaces 114, 116. While the cooling holes 118 are depicted in a combustion liner 88, it is contemplated that the cooling holes 118 can be in any part of the engine where cooling is required by way of non-limiting example the deflector 100, the vanes 60, 62, 72, 74, the blades 56, 58, 68, 70, or a shroud casing for the blades 56, 58, 68, 70.

Each cooling hole 118 includes a passage 120 extending through the combustion liner wall 89 connecting an inlet 122 on the first surface 114 to an outlet 124 on the second surface 116. During operation the flow of fluid 110 is supplied to the bypass channel 108 and emitted through the cooling hole 118 as a cooling flow to create a thin layer or film of cool air on the second surface 116 protecting it from hot air flow within the combustion chamber 90.

The cooling hole 118 includes an inner surface 126 defining the passage 120 extending from the inlet 122 to the outlet 124. The inner surface 126 defines an upstream side 128 and a downstream side 130 of the passage 120. The passage 120 includes a passage centerline 132 where the passage centerline 132 is linear and extends from a geometric center 134 of the cross-sectional area of the inlet 122 to a geometric center 136 of the cross-sectional area of the outlet 124.

The second surface 116 can include a first coating 117 of a bond material to which a second coating 119 of a thermal barrier material is applied. The thermal barrier coating (TBC) can be by way of non-limiting example, YSZ, mullite, alumina, or the like. TBCs are used to insulate engine components from large and prolonged heat loads in order to limit the thermal exposure of the engine components. TBCs coupled with the thin layer or film of cool air enable higher operating temperatures for the engine.

It is noted that, in any of the aspects discussed herein, although the wall 89 is shown as being generally planar, it is understood that that the wall 89 may be a curved wall for many engine components. However, the curvature of the wall 89 may be slight in comparison to the size of the cooling hole 118, and so for the purposes of discussion and illustration, the wall 89 is shown as planar. Whether the wall 89 is planar or curved local to the cooling hole 118, the first and second surfaces 114, 116 may be parallel to each other as shown herein, or may lie in non-parallel planes. The bypass channel 108, need not be the passage from which a flow of fluid 110 is supplied. The bypass channel 108 is an example, and it should be understood that the flow of fluid 110 can be supplied directly to the cooling hole 118, where a wall divides a relatively cool flow of fluid from an area of relatively hotter fluid.

Laser drilling can be used to form the cooling hole 118. Laser drilling is the repeated pulsing of a laser on the material to vaporize the material bit by bit until a hole, through or non-through hole, of the desired depth is reached. Laser drilling is also called percussion drilling. While efficient in creating holes, laser drilling can leave behind jagged edges creating a roughened interior 140 along the inner surface 126. Imperfect sizing and shaping of the inlets 122 and outlets 124 is also a known result of laser drilling. Other forms of hole formation, including other forms of drilling are also contemplated.

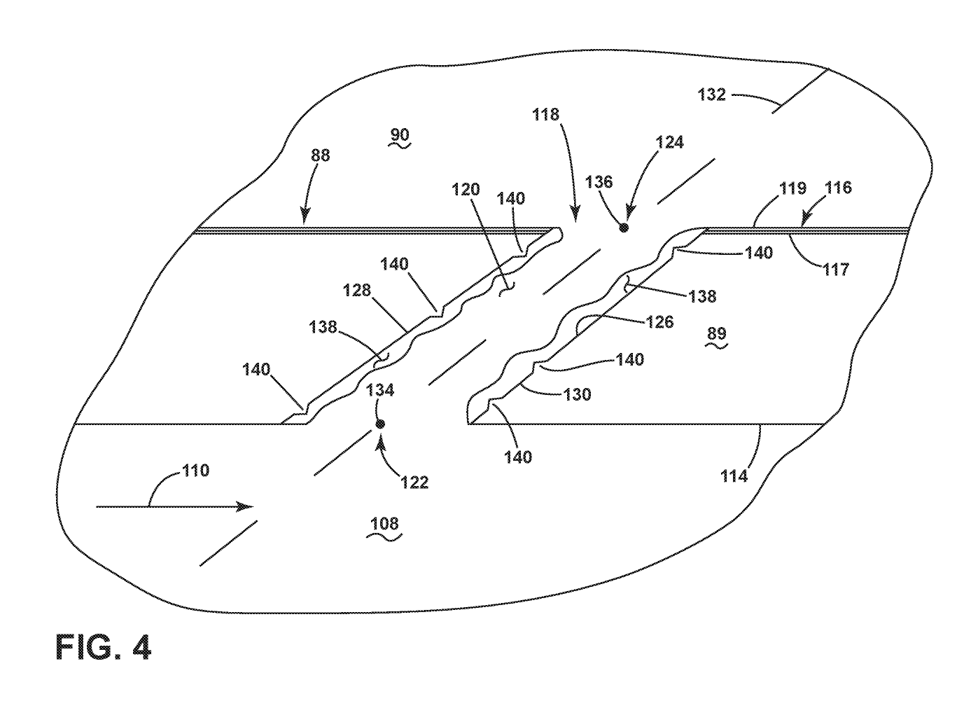

FIG. 4 is the same cross-sectional view of FIG. 3 showing dust accumulation 138 that can occur in cooling holes 118 formed by laser drilling. Over the course of time dust can accumulate 138 along the roughened interior 140 causing partial clogging and in some cases blockage of the cooling hole 118 passage 120 resulting in flow reduction, plugging or undesired directional change of the flow of fluid 110.

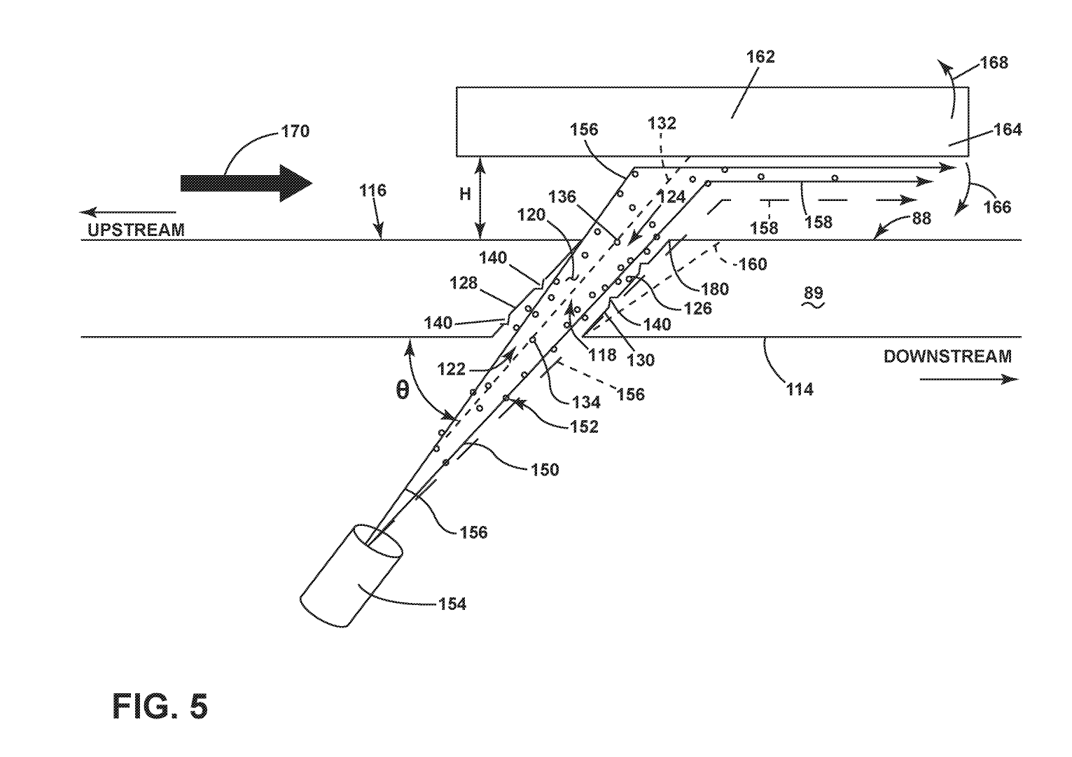

A method of forming the cooling hole 118 in the wall 89 of the combustion liner 88 includes first drilling the hole in a first step as previously described and then a second step is illustrated in FIG. 5. An abrading fluid 150 is passed through the cooling hole 118. By way of a non-limiting example, the abrading fluid 150 is an abrasive material made up of fine particles 152, ranging from 60 to 1000 grits. Other non-limiting examples include water, dry ice, and air. A blaster 154, by way of non-limiting example a grit blaster or water jet, is aligned with the cooling hole 118 along the passage centerline 132 at an acute angle θ between 10° and 30° from the first surface 114. Other non-limiting examples of blasters with which to clean and shape the cooling hole 118 include water jets, advanced lasers, ultrasonic drilling, electrical discharge machining, casting with cooling holes, additive manufacturing, and extrude honing.

The abrading fluid 150 is sprayed from the blaster 154 and passes through the cooling hole 118 exiting the outlet 124 along the second surface 116. As the particles 152 flow through the passage 120 it passes over the roughened interior 140. Smoothing the inner surface 126 of the cooling hole 118 comprises deburring which occurs when friction between the particles 152 and the roughened interior 140 wears down the roughened interior 140 and leaves a smooth inner surface 126.

The abrading fluid 150 is emitted from the outlet 124 in a first direction 156 and then redirected to a second direction 158, which is shown as substantially downstream, of the first direction 156, but could be any other direction. The particles 152 are moved towards an edge 180 on the downstream side 130 of the passage 120. Friction between the particles 152 and the downstream side 130 at the outlet 124 causes a wearing away of the edge 180 elongating the outlet 124 to a desired size 160.

The redirecting of the abrading fluid 150 can be implemented by providing a plate 162 at a height H, where H is 0.5″ or as little as 0.125″ away from the second surface 116 of the wall 89. The H can also be as close as the engine component out-of-roundness will permit. The out-of-roundness determines how close the plate can get to the part and still provide a redirecting of the abrading fluid 150. Movement of a forward end 164 of the plate 162 towards 166 and away 168 from the second surface 116 can change the momentum of the particles 152. The desired size 160 of the outlet 124 is a result of the momentum of the particles 152 and how the particles 152 impact the downstream side 130 of the passage 120 at the outlet 124.

Redirecting the abrading fluid 150 can also be implemented by introducing a stream of air 170 upstream of the outlet 124 such that when abrading fluid 150 exits the outlet 124 it is forced downstream towards the downstream side 130 of the passage 120 by the stream of air 170. While a downstream deflection to smooth the downstream edge of the outlet is described herein, it is appreciated that the flow of the abrading fluid 150 can be redirected in any direction as desired to smooth or elongate any portion of the hole including the inlet, outlet or passage.

It should be appreciated that each implementation of redirecting the fluid with the plate 162 or introducing the stream of air 170 can be implemented separately, together, consecutively one after the other, or intermittently until the desired size 160 of the outlet 124 is achieved.

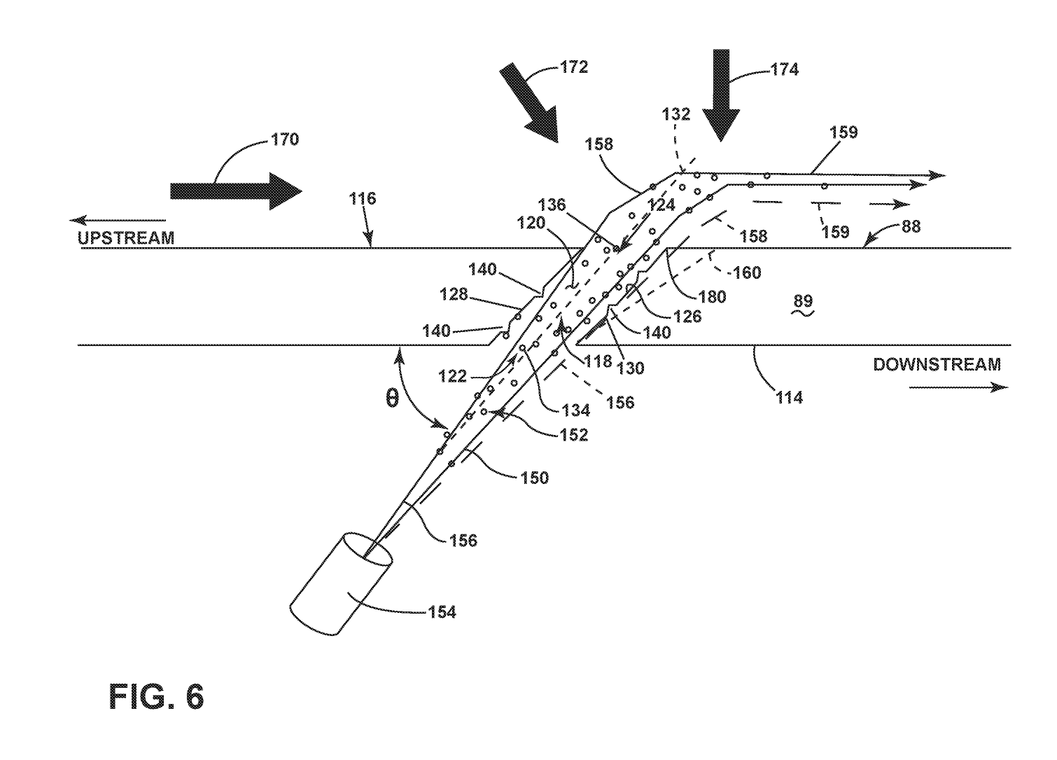

Turning to FIG. 6 it is also contemplated that multiple streams of air 170, 172, 174 can be introduced to redirect the abrading fluid 150 in order to obtain the desired size 160 of the outlet 124. Multiple streams of air 170, 172, 174 can redirect the abrading fluid 150 from the first direction 156 to a second direction 158 and again to a third direction 159. Other directions are also contemplated by way of non-limiting example including out of the page and into the page or from a downstream direction toward an upstream direction.

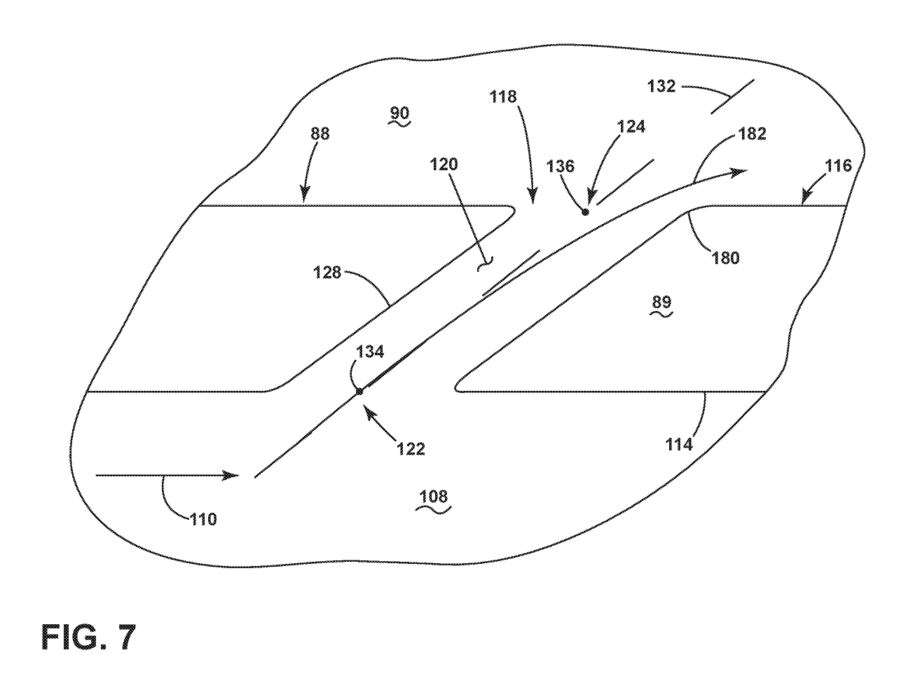

An example of a cooling hole 118 after undergoing the shaping and cleaning is illustrated in FIG. 7. By making the cooling hole 118 inlet 122 conical or using chamfered edges 180 the flow of fluid 110 into the cooling holes 118 follow a more natural path 182 reducing any flow separation that can occur upon existing the outlet 124 which in turn reduces the dust accumulation and increases efficiency.

It is further contemplated that the desired size 160 includes a predetermined shape of the inlet 122 and the outlet 124 and a predetermined shape of the passage 120. By way of non-limiting example predetermined shapes of the inlet and outlet can include cones, circles, ovals, diffuser, and trapezoidal shapes. Non-limiting examples of predetermined shapes of the passage include conical, rectangular, and cylindrical.

Benefits to the method of cleaning and shaping of the cooling holes 118 described herein include reducing dust accumulation in the holes. The cooling holes 118 are used to cool hot section engine components such as the combustor liner 88. By smoothing the cooling hole 118 by way of a non-limiting example to a conical shape, greatly reduces or eliminates dust accumulation and plugging. Additionally smoothing the edges of the inlet 122, inner surface 126, and outlet 124 also reduces dust accumulation and increases efficiency of the flow of fluid 110 for cooling.

Maintaining a flow of fluid 110 into the cooling holes 118 for longer periods of time will increase the life of hot section components. Smoothing the outlet 124 of the cooling hole 118 will further reduce dust accumulation. Grit blasting as described herein after laser drilling holes will smooth the outlet 124 and break up the sharp edges along the inner surface 126 as well as at the inlet 122 and outlet 124

Additional benefits include improving combustor durability, increasing life of hot engine components, achieving longer time on wing (TOW) for engine components discussed herein and having longer maintenance intervals. The cleaner and smoother cooling holes also provide more efficient paths for cooling air and therefore less demand for cooling air which improves the overall efficiency of the engine.

Testing of cooling holes shaped and cleaned with the methods described herein produced results that show significant improvements in flow through the cooling holes when compared to cooling holes left untreated. These tests were conducted on the inner and outer combustor liners for the GE90.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming a hole in a wall of an engine component for a turbine engine, with the wall defining first and second surfaces separating a hot flow from a cooling flow, the method comprising:
forming the hole in the wall such that the hole has an inlet on the first surface, an outlet on the second surface, a passage connecting the inlet and the outlet;
smoothing an interior of the passage by passing an abrading fluid through the passage; and
elongating the outlet by redirecting the abrading fluid as it exits the outlet over an edge defining the outlet to abrade the edge.

2. The method of claim 1 where the engine component is a combustor liner.

3. The method of claim 1 where the elongating the outlet comprises abrading a thermal barrier coating overlying the second surface.

4. The method of claim 3 where the elongating the outlet further comprises abrading a bond coating securing the thermal barrier to the second surface.

5. The method of claim 1 where the forming the hole comprises forming the hole with a laser.

6. The method of claim 1 where the passing the abrading fluid comprises aligning a blaster with the hole at an acute angle of at least 10° from the second surface.

7. The method of claim 6 where the blaster is a grit blaster or a water jet.

8. The method of claim 1 where the smoothing the interior passing comprises deburring the interior of the hole.

9. The method of claim 1 where the passing the abrading fluid comprises reducing dust accumulation.

10. The method of claim 1 where redirecting the abrading fluid as it exits the outlet comprises providing at least one of a stream of air or a plate.

11. The method of claim 10 where the providing at least one of the stream of air or the plate is both providing the stream of air and the plate.

12. The method of claim 10 where the stream of air is multiple streams of air.

13. The method of claim 10 where the redirecting comprises placing the plate at a position of at least 0.125 inches but no more than 2.0 inches from the second surface.

14. A method of forming a cooling hole in an engine component having a first surface with an inlet and a second surface with an outlet comprising:
using a laser to form the cooling hole with a roughened interior passage connecting the inlet to the outlet.
passing an abrading fluid from the inlet to the outlet through the cooling hole to smooth the roughened interior passage of the cooling hole; and
redirecting the abrading fluid at the outlet to elongate the outlet.

15. The method of claim 14 where the engine component is a combustor liner.

16. The method of claim 14 where the passing of the abrading fluid comprises passing a fluid with particles.

17. The method of claim 14 where the passing of the abrading fluid comprises lining up a blaster at an acute angle of at least 10° from the first surface.

18. The method of claim 14 where the passing of the abrading fluid comprises deburring the roughened interior passage.

19. The method of claim 14 where the passing of the abrading fluid comprises reducing dust accumulation.

20. The method of claim 1 where the redirecting comprises placing a plate at a position of at least 0.125 inches but nor more than 2.0 inches from the second surface.

21. The method of claim 14 where the redirecting comprises using at least one stream of air.

22. The method of claim 14 where the cooling hole is formed in a first step and the elongating occurs in a second step.
